(19) United States
(12) Patent Application Publication
(10) Pub. No.: US 2025/0147246 A1
(43) Pub. Date: May 8, 2025

(54) METHOD OF MANUFACTURING OPTICAL COUPLER, OPTICAL COUPLER, PHOTOELECTRIC CONVERSION CIRCUIT MODULE, AND OPTICAL TRANSCEIVER

(71) Applicant: Murata Manufacturing Co., Ltd., Nagaokakyo-shi (JP)

(72) Inventors: Masaki NAGATA, Nagaokakyo-shi (JP); Yasuhiro SHIMIZU, Nagaokakyo-shi (JP); Yuji MIURA, Nagaokakyo-shi (JP); Kazuki NAGASHIMA, Nagaokakyo-shi (JP); Tatsuya TOMIMURA, Nagaokakyo-shi (JP); Naoya MORI, Nagaokakyo-shi (JP); Yutaka SENSHU, Nagaokakyo-shi (JP)

(21) Appl. No.: 19/011,964

(22) Filed: Jan. 7, 2025

Related U.S. Application Data
(63) Continuation of application No. PCT/JP2024/004309, filed on Feb. 8, 2024.

(30) Foreign Application Priority Data
Jul. 26, 2023 (JP) 2023-121574

(51) Int. Cl. G02B 6/42

(52) U.S. Cl. CPC G02B 6/4214

(57) ABSTRACT

A method of manufacturing an optical coupler that includes: preparing a light-transmitting substrate having a first main surface and a second main surface aligned in a first direction; applying a first photosensitive glass paste containing a first filler to the first main surface; arranging a grayscale mask formed in a binary pattern on the second main surface; emitting an ultraviolet ray to the second main surface to expose the first photosensitive glass paste; removing the grayscale mask from the second main surface and developing the first photosensitive glass paste; and removing the light-transmitting substrate from the first photosensitive glass paste developed and curing the first photosensitive glass paste, wherein a longest length of the first filler is larger than a wavelength of the ultraviolet ray.

### CROSS REFERENCE TO RELATED APPLICATIONS

The present application is a continuation of International application No. PCT/JP2024/004309, filed Feb. 8, 2024, which claims priority to Japanese Patent Application No. 2023-121574, filed Jul. 26, 2023, the entire contents of each of which are incorporated herein by reference.

### TECHNICAL FIELD

The present disclosure relates to a method of manufacturing an optical coupler, an optical coupler, a photoelectric conversion circuit module, and optical transceiver.

### BACKGROUND ART

For example, the grayscale mask described in Patent Document 1 is used for the purpose of manufacturing microlenses, and for others. The grayscale mask described in Patent Document 1 includes a plurality of pixels arranged adjacent to each other. One pixel has at least one unit region. The unit region includes a first region that is a light-transmitting region that transmits light and a second region that is a light-shielding region that does not transmit light. The light transmittance of the unit region is determined according to the area ratio between the light-transmitting region and the light-shielding region.
Patent Document 1: Japanese Patent No. 5764948

### SUMMARY OF THE DISCLOSURE

When the grayscale mask described in Patent Document 1 is used as a photomask in manufacturing an optical coupler such as a microlens, light is diffracted during exposure by the periodic structure of the light-transmitting region and the light-shielding region. A high level of the diffracted light is emitted in a direction other than the intended direction. Therefore, the photosensitive material is not exposed as designed, and processing accuracy may decrease.

Therefore, an object of the present disclosure is to provide a method of manufacturing an optical coupler, an optical coupler, a photoelectric conversion circuit module, and an optical transceiver capable of suppressing a decrease in processing accuracy.

A method of manufacturing an optical coupler according to an embodiment of the present disclosure includes: preparing a light-transmitting substrate having a first main surface and a second main surface aligned in a first direction; applying a first photosensitive glass paste containing a first filler to the first main surface; arranging a grayscale mask formed in a binary pattern on the second main surface; emitting an ultraviolet ray to the second main surface to expose the first photosensitive glass paste; removing the grayscale mask from the second main surface and developing the first photosensitive glass paste; and removing the light-transmitting substrate from the first photosensitive glass paste developed and curing the first photosensitive glass paste, in which a longest length of the first filler is larger than a wavelength of the ultraviolet ray.

In a case where the longest length of the first filler is larger than the wavelength of the ultraviolet ray, the ultraviolet ray diffracted by the grayscale mask is scattered by the first filler. As a result, a high level of the diffracted light is not emitted in a direction other than the intended direction. Therefore, the present embodiment can suppress a decrease in processing accuracy.

A method of manufacturing an optical coupler according to an embodiment of the present disclosure includes: preparing a light-transmitting substrate having a first main surface and a second main surface aligned in a first direction and containing a third filler; applying a first photosensitive glass paste to the first main surface; arranging a grayscale mask formed in a binary pattern on the second main surface; emitting an ultraviolet ray to the second main surface to expose the first photosensitive glass paste; removing the grayscale mask from the second main surface and developing the first photosensitive glass paste; and removing the light-transmitting substrate from the first photosensitive glass paste developed and curing the first photosensitive glass paste, in which a longest length of the third filler is larger than a wavelength of the ultraviolet ray.

Also, in a case where the longest length of the third filler is larger than the wavelength of the ultraviolet ray, the ultraviolet ray diffracted by the grayscale mask is scattered by the third filler. As a result, a high level of the diffracted light is not emitted in a direction other than the intended direction. Therefore, the present embodiment can also suppress a decrease in processing accuracy.

An optical coupler according to an embodiment of the present disclosure includes: a first photosensitive glass paste containing a first filler, in which a longest length of the first filler is larger than a wavelength of an ultraviolet ray to be emitted to a grayscale mask formed in a binary pattern.

An optical coupler according to an embodiment of the present disclosure includes: a first glass part containing first glass and a first filler mixed in the first glass; and a second glass part that contains at least second glass and is connected to the first glass part, in which (1) the second glass part contains a second filler mixed in the second glass, and a content of the second filler contained in the second glass part is lower than a content of the first filler contained in the first glass part, or (2) the second glass part does not contain the second filler.

In this embodiment, the second glass part has no filler, or has a filler content lower than that of the first glass part, but when the first glass part emits an ultraviolet ray, diffracted light generated during manufacturing is diffused by the first filler of the first glass part having a relatively high content. As a result, a high level of the diffracted light is not emitted in a direction other than the intended direction. Therefore, the present embodiment can also suppress a decrease in processing accuracy.

An optical coupler according to an embodiment of the present disclosure includes: a first glass part; and a transparent part connected to the first glass part, in which the first glass part contains glass and a first filler mixed in the glass, the transparent part contains a medium and a second filler mixed in the medium, and a longest length of the second filler is different from a longest length of the first filler.

In this embodiment, an ultraviolet ray is emitted, of the first glass part or the transparent part, to the first glass part or the transparent part containing a filler having a larger longest length, whereby the diffracted light is diffused. As a result, a high level of the diffracted light is not emitted in a direction other than the intended direction. Therefore, the present embodiment can also suppress a decrease in processing accuracy.

According to the method of manufacturing an optical coupler, the optical coupler, the photoelectric conversion circuit module, and the optical transceiver of the present disclosure, a decrease in processing accuracy can be suppressed.

### BRIEF EXPLANATION OF THE DRAWINGS

FIG. 1 is a perspective view of an optical coupler 1.

FIG. 2 is a sectional view of the optical coupler 1 and an optical fiber 5.

FIG. 3 is a plan view of the optical coupler 1 as viewed in a first direction DIR1.

FIG. 4 is a flowchart illustrating a method of manufacturing the optical coupler 1.

FIG. 5 is a sectional view during the manufacturing of the optical coupler 1.

FIG. 6 is views illustrating pixels 15 of a grayscale mask 10.

FIG. 7 is a view illustrating a pattern in which the pixels 15 of the grayscale mask 10 are arranged in order of aperture ratio.

FIG. 8 is an example of the grayscale mask 10 corresponding to the optical coupler 1.

FIG. 9 is a light intensity distribution of a comparative example in an exposure step.

FIG. 10 is a light intensity distribution of a first embodiment in the exposure step.

FIG. 11 is a perspective view of a light-transmitting substrate 11.

FIG. 12 is a sectional view of an optical coupler 1b and the optical fiber 5.

FIG. 13 is a flowchart illustrating a method of manufacturing the optical coupler 1b.

FIG. 14 is a sectional view during the manufacturing of the optical coupler 1b.

FIG. 15 is a sectional view of an optical coupler 1c and the optical fiber 5.

FIG. 16 is a sectional view during the manufacturing of the optical coupler 1c.

FIG. 17 is a sectional view of an optical coupler 1d and the optical fiber 5.

FIG. 18 is a perspective view of a photoelectric conversion circuit module 50 and the optical fiber 5.

FIG. 19 is an A-A sectional view of the photoelectric conversion circuit module 50 and the optical fiber 5.

FIG. 20 is a perspective view of a photoelectric conversion circuit module 50a and the optical fiber 5.

FIG. 21 is a perspective view of an optical transceiver 100 and the optical fiber 5.

### DESCRIPTION OF THE PREFERRED EMBODIMENTS

### First Embodiment

### [Structure of Optical Coupler 1]

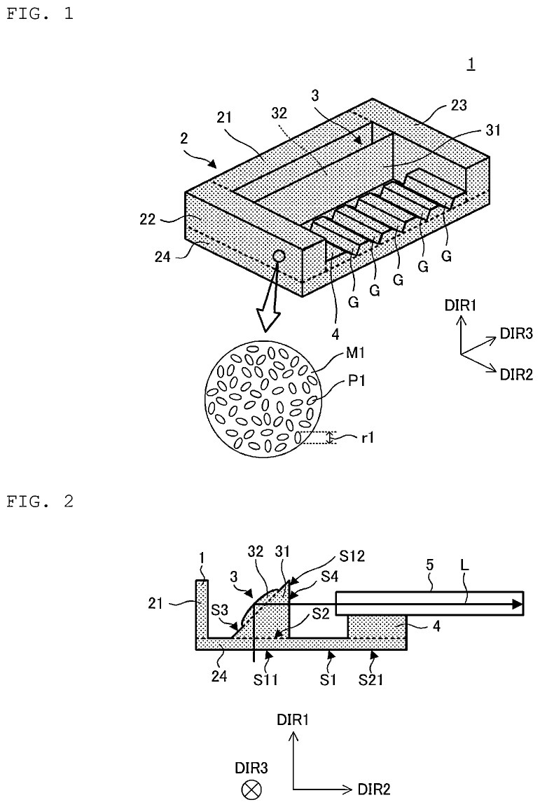

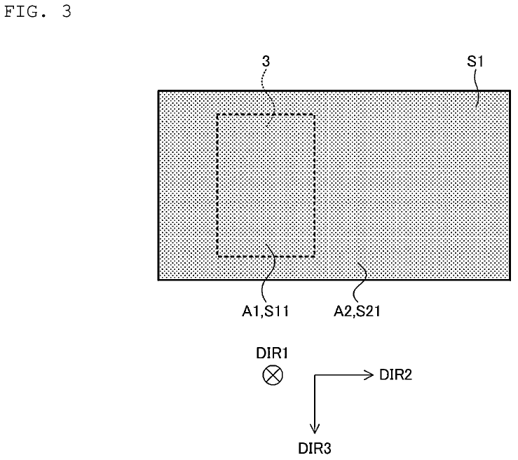

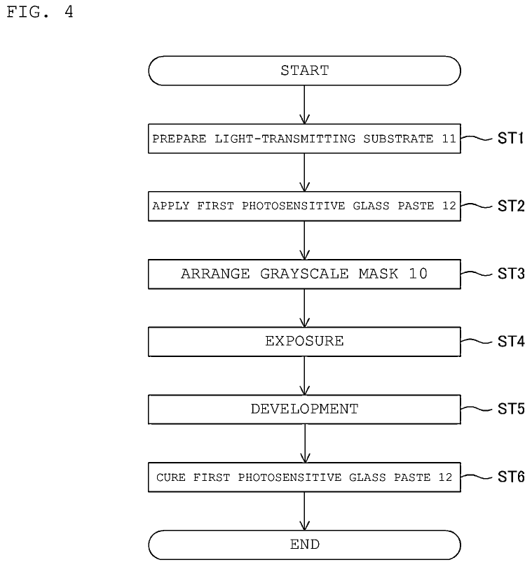

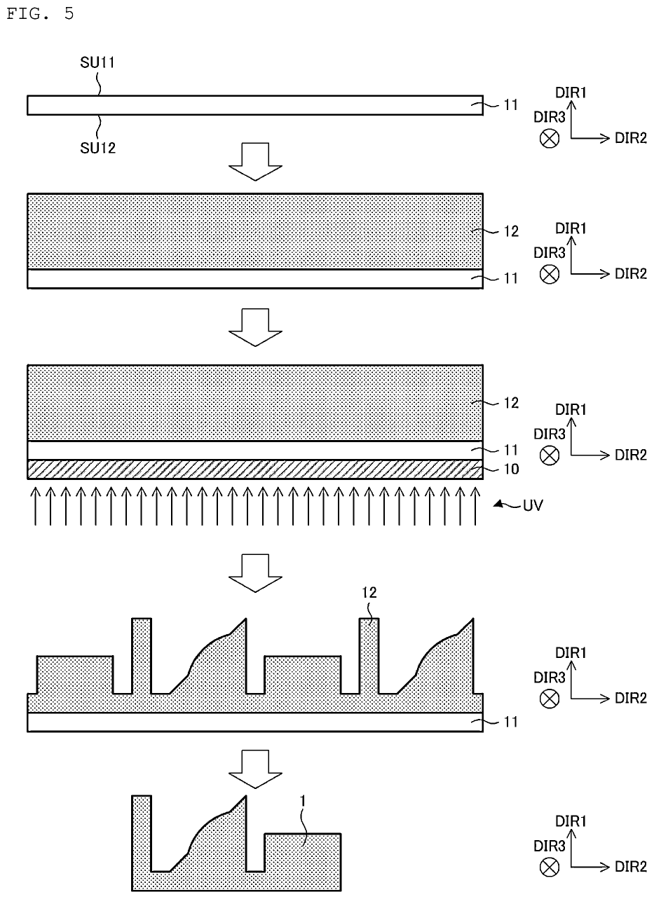

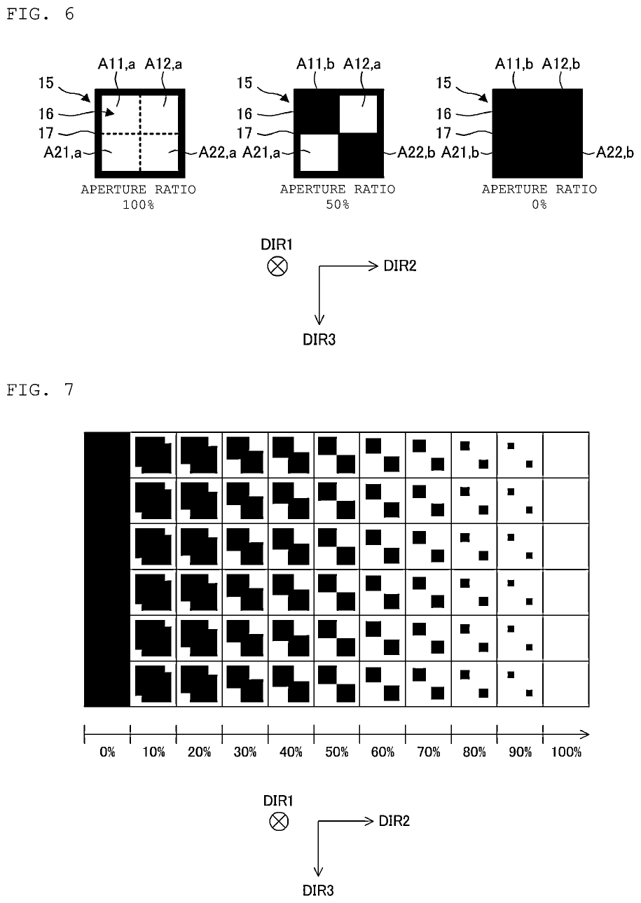

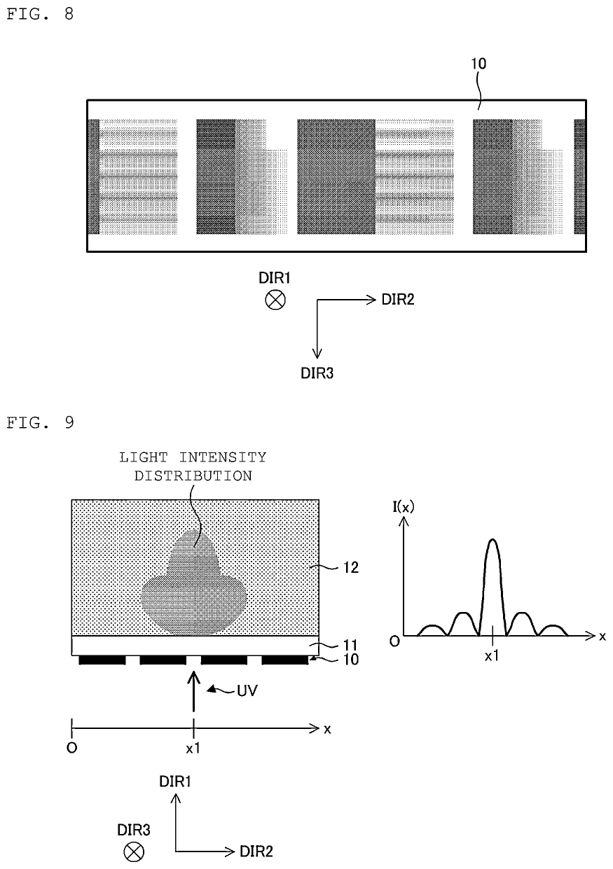

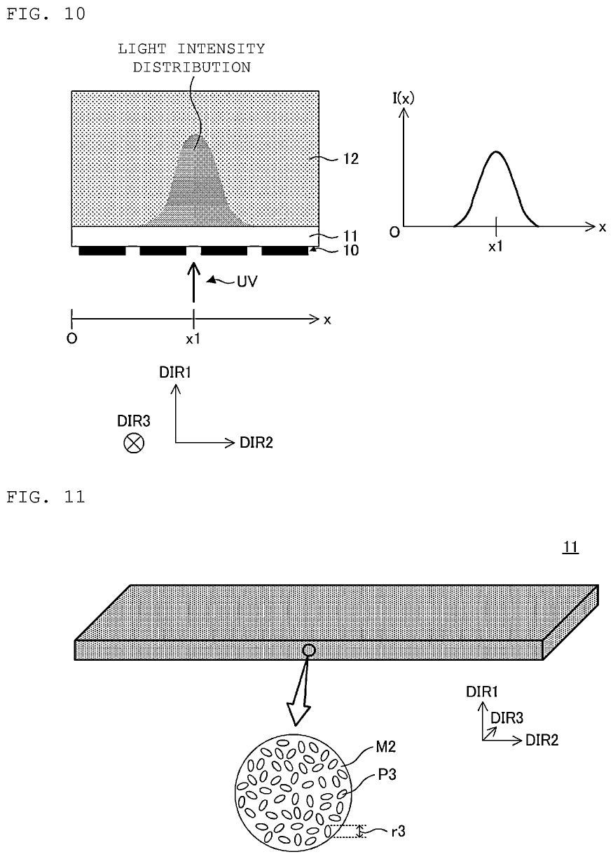

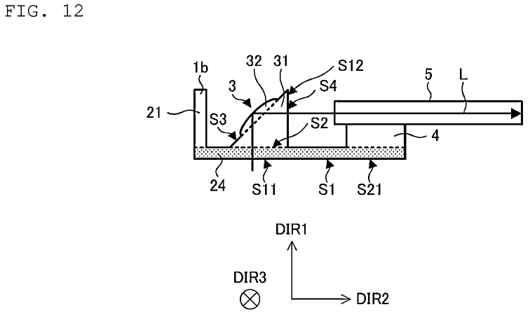

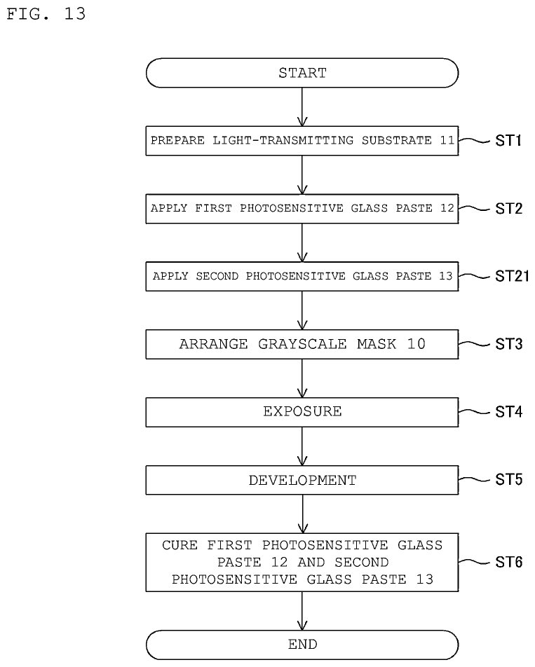

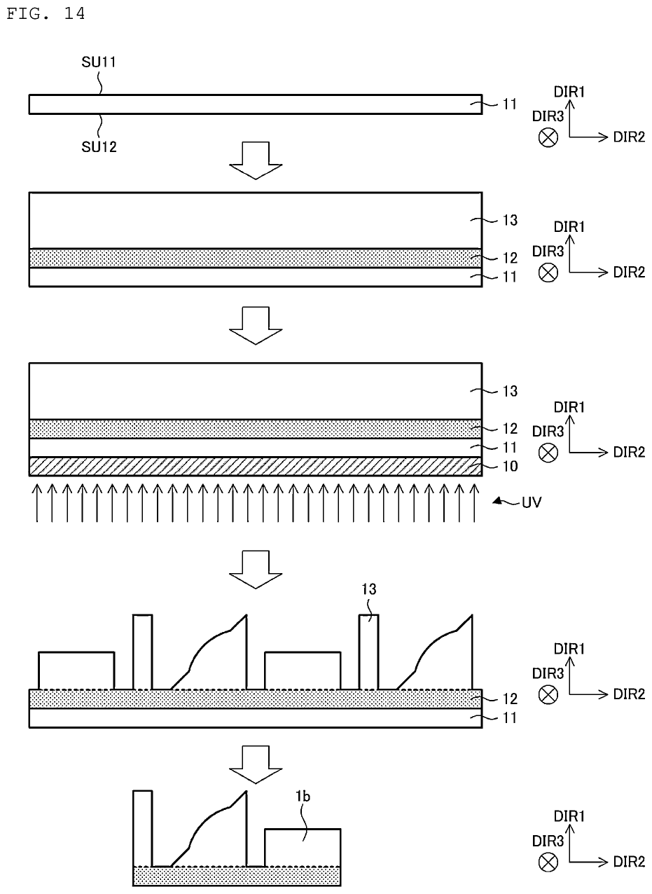

Hereinafter, an optical coupler 1 according to a first embodiment of the present disclosure will be described with reference to the drawings. FIG. 1 is a perspective view of the optical coupler 1. Note that, in FIG. 1, a representative first filler P1 among a plurality of first fillers P1 is only denoted by a reference symbol. FIG. 2 is a sectional view of the optical coupler 1 and an optical fiber 5. Note that, in FIG. 2, a second side wall part 22 and a third side wall part 23 are omitted. FIG. 3 is a plan view of the optical coupler 1 as viewed in a first direction DIR1.

In the present description, directions are defined as follows. As illustrated in FIG. 1, a direction in which a bottom part 24 and a reflective part 3 are aligned in this order is defined as a first direction DIR1. A direction in which the reflective part 3 and an optical fiber fixing part 4 are aligned in this order is defined as a second direction DIR2. A direction in which the second side wall part 22 and the third side wall part 23 are aligned in this order is defined as a third direction DIR3. The first direction DIR1, the second direction DIR2, and the third direction DIR3 are orthogonal to each other. However, the first direction DIR1, the second direction DIR2, and the third direction DIR3 in the present description are directions defined for convenience of explanation, and may not match the first direction DIR1, the second direction DIR2, and the third direction DIR3 when the optical coupler 1 is used.

The optical coupler 1 is an apparatus that changes the traveling direction of the light emitted from a photoelectric conversion circuit or the like to emit the light to an optical fiber, or that changes the traveling direction of the light emitted from an optical fiber to emit the light to a photoelectric conversion circuit or the like. In the present embodiment, a case, where the optical coupler 1 changes the traveling direction of light L emitted from a photoelectric conversion circuit or the like from the first direction DIR1 to the second direction DIR2 and emits the light L to the optical fiber 5, will be described. As illustrated in FIG. 2, the optical coupler 1 includes an incident surface S11 on which the light L is incident in the first direction DIR1 and an emission surface S12 from which the light L is emitted in the second direction DIR2. Note that, in a case where the optical coupler 1 changes the traveling direction of the light L emitted from the optical fiber 5 from a direction opposite to the second direction DIR2 to a direction opposite to the first direction DIR1 and emits the light L to a photoelectric conversion circuit or the like, the incident surface and the emission surface may be interchanged. Note that the optical coupler 1 is an example of the “optical coupler” of the present disclosure. The “optical coupler” of the present disclosure may be a condenser lens, a microlens array, or the like. Hereinafter, the structure of the optical coupler 1 will be described in detail.

As illustrated in FIG. 1, the optical coupler 1 includes a holding part 2, the reflective part 3, and the optical fiber fixing part 4. The optical coupler 1 is integrally molded with glass containing fillers. The optical coupler 1 is a single member. Here, the single member means a member having a structure that cannot be separated without being damaged. Therefore, for example, a member in which two resin pieces are fixed by screws is not the single member. Note that the optical coupler 1 may not be integrally molded with glass containing fillers. In addition, the optical coupler 1 may not be the single member.

The optical coupler 1 is integrally molded with a material containing glass M1 and a plurality of first fillers P1 mixed in the glass M1. Glass is a material that is amorphous and exhibits a glass transition phenomenon. Examples of the glass include: glass of simple oxides such as SiO₂, B₂O₃, P₂O₅, GeO₂, and AS3O₃; glass of silicates such as Li₂O—SiO₂, Na₂O—SiO₂, and K₂O—SiO₂; glass of aluminosilicates such as Na₂O—Al₂O₃—SiO₂ and CaO—Al₂O₃—SiO₂; glass of borates such as Li₂O—B₂O₃ and Na₂O—B₂O₃; glass of aluminoborates such as CaO—Al₂O₃—B₂O₃; and glass of borosilicates such as Na₂O—Al₂O₃—B₂O₃—SiO₂.

The plurality of first fillers P1 are metal oxide particles such as crystalline silica, amorphous silica, alumina, magnesium oxide, titanium oxide, barium titanate, or calcium titanate, or organic particles such as graphite. The first fillers P1 include a filler having a non-spherical shape. The plurality of first fillers P1 are dispersed throughout the glass M1. Note that the first fillers P1 may not include a filler having a non-spherical shape. In addition, the plurality of first fillers P1 may be uniformly dispersed throughout the glass M1, or may be non-uniformly dispersed throughout the glass M1.

The longest length of each of the plurality of first fillers P1 is defined as r1. Note that, in a case where each of the plurality of first fillers P1 has a spherical shape, the longest length r1 of each of the plurality of first fillers P1 is the diameter of the sphere. In a case where each of the plurality of first fillers P1 has an elliptical spherical shape, the longest length r1 of each of the plurality of first fillers P1 is the length, in the major axis direction, of the elliptical sphere. As described above, the longest length r1 of each of the plurality of first fillers P1 is the length, in the longitudinal direction, of the longest portion of each of the plurality of first fillers P1. In the present embodiment, the maximum value of the longest length r1 of each of the plurality of first fillers P1 is larger than a wavelength λ of an ultraviolet ray UV to be described later. That is, there is the first filler P1 having the longest length r1 larger than the wavelength λ of the ultraviolet ray UV.

The holding part 2 holds each of the reflective part 3 and the optical fiber fixing part 4. The holding part 2 is connected to each of the reflective part 3 and the optical fiber fixing part 4. The holding part 2 includes a first side wall part 21, the second side wall part 22, the third side wall part 23, and the bottom part 24. Note that the holding part 2 may not include each of the first side wall part 21, the second side wall part 22, and the third side wall part 23.

The first side wall part 21 is connected to each of the second side wall part 22, the third side wall part 23, and the bottom part 24. In more detail, the first side wall part 21 has a shape extending in the third direction DIR3. In the present embodiment, the first side wall part 21 has a plate shape. The end surface, in the third direction DIR3, of the first side wall part 21 is connected to the third side wall part 23. The end surface, in a direction opposite to the third direction DIR3, of the first side wall part 21 is connected to the second side wall part 22. The end surface, in the direction opposite to the first direction DIR1, of the first side wall part 21 is connected to the bottom part 24. Note that the first side wall part 21 may not have a plate shape.

The second side wall part 22 is connected to each of the first side wall part 21, the bottom part 24, the reflective part 3, and the optical fiber fixing part 4. In more detail, the second side wall part 22 has a shape extending in the second direction DIR2. In the present embodiment, the second side wall part 22 has a plate shape. A part of the end surface, in the third direction DIR3, of the second side wall part 22 is connected to each of the end surface, in the direction opposite to the third direction DIR3, of the first side wall part 21, the reflective part 3, and the optical fiber fixing part 4. The end surface, in the direction opposite to the first direction DIR1, of the second side wall part 22 is connected to the bottom part 24. Note that the second side wall part 22 may not have a plate shape.

The third side wall part 23 is connected to each of the first side wall part 21, the bottom part 24, the reflective part 3, and the optical fiber fixing part 4. In more detail, the third side wall part 23 has a shape extending in the second direction DIR2. In the present embodiment, the third side wall part 23 has a plate shape. A part of the end surface, in the direction opposite to the third direction DIR3, of the third side wall part 23 is connected to each of the end surface, in the third direction DIR3, of the first side wall part 21, the reflective part 3, and the optical fiber fixing part 4. The end surface, in the direction opposite to the first direction DIR1, of the third side wall part 23 is connected to the bottom part 24. Note that the third side wall part 23 may not have a plate shape.

The bottom part 24 is connected to each of the first side wall part 21, the second side wall part 22, the third side wall part 23, the reflective part 3, and the optical fiber fixing part 4. In more detail, the bottom part 24 has a plate shape. In the present embodiment, the bottom part 24 has a rectangular shape as viewed in the first direction DIR1. A part of the end surface, in the first direction DIR1, of the bottom part 24 is connected to each of the end surface, in the direction opposite to the first direction DIR1, of the first side wall part 21, the end surface, in the direction opposite to the first direction DIR1, of the second side wall part 22, the end surface, in the direction opposite to the first direction DIR1, of the third side wall part 23, the reflective part 3, and the optical fiber fixing part 4. Note that the bottom part 24 may not have a rectangular shape as viewed in the first direction DIR1.

As illustrated in FIG. 2, the light L enters the optical coupler 1 from an end surface S1, in the direction opposite to the first direction DIR1, of the bottom part 24. Therefore, the end surface S1, in the direction opposite to the first direction DIR1, of the bottom part 24 includes the incident surface Sli of the optical coupler 1. The light L having entered the bottom part 24 from the end surface S1, in the direction opposite to the first direction DIR1, of the bottom part 24 passes through the inside of the bottom part 24 to enter the reflective part 3.

Here, in the end surface S1, in the direction opposite to the first direction DIR1, of the bottom part 24, a region overlapping the reflective part 3 as viewed in the first direction DIR1 is defined as a region A1, as illustrated in FIG. 3. In the end surface S1, in the direction opposite to the first direction DIR1, of the bottom part 24, a region not overlapping the reflective part 3 as viewed in the first direction DIR1 is defined as a region A2. The end surface S1, in the direction opposite to the first direction DIR1, of the bottom part 24 includes both the region A1 and the region A2. The light L enters the optical coupler 1 from the region A1 of the bottom part 24. Therefore, the region A1 is the incident surface S11. The region A2 is a mounting surface S21 for mounting the optical coupler 1 on a substrate when the optical coupler 1 is incorporated into a photoelectric conversion circuit module or the like. The end surface S1, in the direction opposite to the first direction DIR1, of the bottom part 24 includes the incident surface S11 and the mounting surface S21. That is, the mounting surface S21 is in the same plane as that of the incident surface S11.

As illustrated in FIG. 1, the reflective part 3 is connected to each of the second side wall part 22, the third side wall part 23, and the bottom part 24. As illustrated in FIG. 2, the reflective part 3 changes the traveling direction of the light L having entered from the incident surface S11 from the first direction DIR1 to the second direction DIR2, and emits the light L to one of the five optical fibers 5. The reflective part 3 includes a prism part 31 and five condenser lens parts 32. Note that the number of the condenser lens parts 32 is not limited to five. In addition, the reflective part 3 may not include the condenser lens parts 32.

The prism part 31 is connected to each of the second side wall part 22, the third side wall part 23, and the bottom part 24. In more detail, in the present embodiment, the prism part 31 has a right isosceles triangular prism shape extending in the third direction DIR3. The prism part 31 includes a prism part incident surface S2, a prism part reflective surface S3, a prism part emission surface S4, an end surface in the third direction DIR3, and an end surface in the direction opposite to the third direction DIR3. The end surface, in the third direction DIR3, of the prism part 31 is connected to the third side wall part 23. The end surface, in the direction opposite to the third direction DIR3, of the prism part 31 is connected to the second side wall part 22. Note that the prism part 31 may not have a right isosceles triangular prism shape.

The prism part incident surface S2 is the end surface, in the direction opposite to the first direction DIR1, of the prism part 31. The prism part incident surface S2 is connected to the bottom part 24. The light L having passed through the inside of the bottom part 24 enters the prism part 31 from the prism part incident surface S2. The light L having entered the prism part 31 from the prism part incident surface S2 passes through the inside of the prism part 31.

The prism part reflective surface S3 forms an angle of 45 degrees with each of the prism part incident surface S2 and the prism part emission surface S4 as viewed in the third direction DIR3. The end, in the first direction DIR1, of the prism part reflective surface S3 is located closer to the second direction DIR2 than the end, in the direction opposite to the first direction DIR1, of the prism part reflective surface S3 is. The prism part reflective surface S3 reflects the light L having passed through the inside of the prism part 31. As a result, the prism part reflective surface S3 changes the traveling direction of the light L from the first direction DIR1 to the second direction DIR2.

The five condenser lens parts 32 are provided on the prism part reflective surface S3. The five condenser lens parts 32 are aligned in the third direction DIR3. The surface of the condenser lens part 32 has an aspherical shape. The condenser lens part 32 reflects the light L, which has passed through the inside of the prism part 31 and the vector, in the traveling direction, of which includes a component in the first direction DIR1, while condensing the light L. As a result, the condenser lens part 32 changes the traveling direction of the light L from the direction including the component in the first direction DIR1 to the second direction DIR2.

The prism part emission surface S4 is the end surface, in the first direction DIR1, of the prism part 31. The prism part emission surface S4 is orthogonal to the prism part incident surface S2. The prism part emission surface S4 emits the light L that has been reflected by the prism part reflective surface S3 or the condenser lens part 32 and has passed through the inside of the prism part 31. The light L emitted from the prism part emission surface S4 travels in the first direction DIR1. The prism part emission surface S4 is the emission surface S12 of the optical coupler 1.

The optical fiber fixing part 4 fixes each of the five optical fibers 5. The optical fiber fixing part 4 is connected to each of the second side wall part 22, the third side wall part 23, and the bottom part 24. In more detail, the optical fiber fixing part 4 has a plate shape extending in the third direction DIR3. In the present embodiment, the end surface, in the third direction DIR3, of the optical fiber fixing part 4 is connected to the third side wall part 23. The end surface, in the direction opposite to the third direction DIR3, of the optical fiber fixing part 4 is connected to the second side wall part 22. The end surface, in the direction opposite to the first direction DIR1, of the optical fiber fixing part 4 is connected to the bottom part 24.

As illustrated in FIG. 1, five grooves G, each having a V-shape as viewed in the second direction DIR2, are provided in the end surface, in the first direction DIR1, of the optical fiber fixing part 4. Each of the five grooves G has a shape extending in the second direction DIR2. The five grooves G are aligned in the third direction DIR3. As illustrated in FIG. 2, each of the five optical fibers 5 is fixed to each of the five grooves G. The five optical fibers 5 are aligned in the third direction DIR3. Each of the five optical fibers 5 and the five condenser lens parts 32 are aligned in the second direction DIR2 as viewed in the first direction DIR1. Note that the grooves G may not be provided in the end surface, in the first direction DIR1, of the optical fiber fixing part 4. Each of the five grooves G may have a U-shape as viewed in the second direction DIR2. In addition, the number of the grooves G is not limited to five.

Each of the five optical fibers 5 has a shape extending in the second direction DIR2. The end surface, in the direction opposite to the second direction DIR2, of each of the five optical fibers 5 faces the direction opposite to the second direction DIR2. The end surface, in the direction opposite to the second direction DIR2, of each of the five optical fibers 5 faces the prism part emission surface S4 with a gap therebetween. As a result, the light L emitted from the prism part emission surface S4 is incident on one of the five optical fibers 5.

### [Method of Manufacturing Optical Coupler 1]

Next, a method of manufacturing the optical coupler 1 will be described with reference to the drawings. FIG. 4 is a flowchart illustrating the method of manufacturing the optical coupler 1. FIG. 5 is a sectional view during the manufacturing of the optical coupler 1. Note that, in FIG. 5, the second side wall part 22 and the third side wall part 23 are omitted. FIG. 6 is views illustrating pixels 15 of a grayscale mask 10. FIG. 7 is a view illustrating a pattern in which the pixels 15 of the grayscale mask 10 are arranged in order of aperture ratio. FIG. 8 is an example of the grayscale mask 10 corresponding to the optical coupler 1.

First, as illustrated in FIG. 5, a light-transmitting substrate 11, having a first main surface SU11 and a second main surface SU12 aligned in the first direction DIR1, is prepared (preparation step, FIG. 4: step ST1). The first main surface SU11 is located closer to the first direction DIR1 than the second main surface SU12 is. The light-transmitting substrate 11 has a plate shape.

Next, first photosensitive glass paste 12 is applied to the first main surface SU11 of the light-transmitting substrate 11 (first application step, FIG. 4: step ST2). In the present embodiment, the first photosensitive glass paste 12 is of a negative type. In a developing step to be described later, solubility of an exposed portion in a developing solution is reduced. As a result, the exposed portion of the first photosensitive glass paste 12 remains. Note that the first photosensitive glass paste 12 may be of a positive type. In this case, solubility of the exposed portion in the developing solution is increased in the developing step to be described later. As a result, an unexposed portion of the first photosensitive glass paste 12 remains. Note that the first photosensitive glass paste 12 contains the glass M1 and the plurality of first fillers P1 mixed in the glass M1. The first photosensitive glass paste 12 may contain additives, such as a dispersant and a light absorbent, in addition to the glass M1 and the plurality of first fillers P1 mixed in the glass M1.

Next, the grayscale mask 10 is arranged on the second main surface SU12 of the light-transmitting substrate 11 (mask step, FIG. 4: step ST3). The grayscale mask 10 is formed in a binary pattern. The grayscale mask 10 adjusts the light transmittance by controlling an aperture ratio. Hereinafter, the grayscale mask 10 will be described in detail.

As illustrated in FIG. 6, the grayscale mask 10 has a configuration in which a plurality of pixels 15 are arranged adjacent to each other. The pixel 15 includes a unit region 16 and a runner part 17. The unit region 16 has a square shape as viewed in the first direction DIR1. Furthermore, the unit region 16 is divided into four square parts A11, A12, A21, and A22. The runner part 17 is arranged around the unit region 16 as viewed in the first direction DIR1. The runner part 17 is a light-shielding region b that does not transmit light.

The unit region 16 includes a light-transmitting region a that is open (transmits light) and the light-shielding region b that is not open (does not transmit light). The unit region 16 is configured such that the aperture ratio (light transmittance) in the unit region 16 changes as the area ratio between the light-transmitting region a and the light-shielding region b changes.

For example, when all of the four square parts A11, A12, A21, and A22 are open, the aperture ratio in the unit region 16 is 100%. When all of the two square parts A12 and A21 are open and all of the two square parts A11 and A22 are not open, the area ratio between the light-transmitting region a and the light-shielding region b is 1:1, and the aperture ratio (light transmittance) in the unit region 16 is 50%. When all of the four square parts A11, A12, A21, and A22 are not open, the aperture ratio in the unit region 16 is 0%.

When the unit regions 16 having an aperture ratio of 0% to 100% in the grayscale mask 10 are aligned in this order in the second direction DIR2, as illustrated in FIG. 7, the pattern of the grayscale mask 10 becomes gradation. In FIG. 7, the unit regions 16 with an aperture ratio differing by 10% each are sequentially aligned. However, the resolution of the aperture ratio is increased by sequentially aligning the unit regions 16 with an aperture ratio differing, for example, by 0.1% each, whereby the continuity of the light transmittance can be maintained. In this manner, the grayscale mask 10 adjusts the light transmittance by controlling the aperture ratio.

As illustrated in FIG. 8, the optical coupler 1 can be manufactured using the grayscale mask 10 by increasing the aperture ratios in portions of the grayscale mask 10 corresponding to the first side wall part 21, the second side wall part 22, and the third side wall part 23 and reducing the aperture ratio in a portion of the grayscale mask 10 corresponding to the groove G, and by others.

Next, as illustrated in FIG. 5, the second main surface SU12 of the light-transmitting substrate 11 is irradiated with the ultraviolet ray UV to expose the first photosensitive glass paste 12 (exposure step, FIG. 4: step ST4). The wavelength λ of the ultraviolet ray UV is between 10 nm and 380 nm. Through the exposure step, the first photosensitive glass paste 12 is exposed to light. In the present embodiment, the maximum value of the longest length r1 of each of the plurality of first fillers P1 is larger than the wavelength λ of the ultraviolet ray UV, as described above.

Next, the grayscale mask 10 is removed from the second main surface SU12 of the light-transmitting substrate 11, and the first photosensitive glass paste 12 is developed (developing step, FIG. 4: step ST5). In more detail, the first photosensitive glass paste 12 and the light-transmitting substrate 11 are immersed in a developing solution. Through the developing step, exposed portions of the first photosensitive glass paste 12 remain, and unexposed portions are removed. After the development, the first photosensitive glass paste 12 and the light-transmitting substrate 11 are washed and dried.

Finally, the light-transmitting substrate 11 is removed from the first photosensitive glass paste 12 developed, and the first photosensitive glass paste 12 is cured (curing step, FIG. 4: step ST6). In more detail, the first photosensitive glass paste 12 is fired to cure the first photosensitive glass paste 12. The optical coupler 1 is completed through the above steps. Note that a plurality of the optical couplers 1 may be completed by: arranging the grayscale mask 10 corresponding to the plurality of the optical couplers 1 on the second main surface SU12 of the light-transmitting substrate 11; and after the first photosensitive glass paste 12 is cured, cutting the first photosensitive glass paste 12 cured, as illustrated in FIG. 5.

### Effects

According to the method of manufacturing the optical coupler 1, a decrease in processing accuracy can be suppressed. As a comparative example, a method of manufacturing an optical coupler containing no filler will be described with reference to the drawings. FIG. 9 is a light intensity distribution of a comparative example in the exposure step. FIG. 10 is a light intensity distribution of the first embodiment in the exposure step. Note that, in FIGS. 9 and 10, the ultraviolet ray UV is a laser beam. The beam diameter of the ultraviolet ray UV is sufficiently smaller than the light-transmitting region a.

In the exposure step, the ultraviolet ray UV is diffracted by the periodic structure of the light-transmitting region a and the light-shielding region b of the grayscale mask 10. In a case where the first photosensitive glass paste 12 contains no filler, high levels of light are distributed at positions other than a position x1, in the second direction DIR2, of the ultraviolet ray UV, as illustrated in FIG. 9. Therefore, the portions, other than the position x1, of the first photosensitive glass paste 12 are also exposed to high levels of the ultraviolet ray UV. In the present embodiment, the first photosensitive glass paste 12 is of a negative type. Therefore, the portions, other than the position x1, of the first photosensitive glass paste 12 are more likely to remain in the developing step. As described above, the light distributed in the portions other than the position x1 causes a decrease in processing accuracy.

Therefore, according to the method of manufacturing the optical coupler 1, the first photosensitive glass paste 12 contains the first fillers P1. The longest length r1 of the first filler P1 is larger than the wavelength λ of the ultraviolet ray UV. As a result, the ultraviolet ray UV diffracted by the periodic structure of the light-transmitting region a and the light-shielding region b of the grayscale mask 10 is scattered by the first fillers P1. As a result, the light intensity distribution of the ultraviolet ray UV becomes a normal distribution that is the strongest at the position x1, in which the light intensities I (x) distributed at positions other than the position x1 become smaller than those of the comparative example as illustrated in FIG. 10, and the positions other than the position x1 are not irradiated with high levels of the ultraviolet ray UV. Therefore, the portions, other than the position x1, of the first photosensitive glass paste 12 are less likely to remain in the developing step. As a result, according to the method of manufacturing the optical coupler 1, a decrease in processing accuracy can be suppressed.

Note that, in a case where the longest length r1 of the first filler P1 is equal to or smaller than the wavelength λ of the ultraviolet ray UV, scattering of the ultraviolet ray UV is suppressed. Therefore, when the grayscale mask 10 formed in a binary pattern is used, the longest length r1 of the first filler P1 is larger than the wavelength λ of the ultraviolet ray UV, so that scattering of the ultraviolet ray UV is generated, and the light intensities I (x) to be distributed at the positions other than the position x1, in the second direction DIR2, of the ultraviolet ray UV can be reduced.

In addition, according to the method of manufacturing the optical coupler 1, the content of the first filler P1 contained in the first photosensitive glass paste 12 can be reduced. In more detail, the first fillers P1 include a filler having a non-spherical shape. Compared to the case where the first filler P1 contains only a filler having a spherical shape, this makes it possible to further generate scattering of the ultraviolet ray UV. As a result, according to the method of manufacturing the optical coupler 1, the content of the first filler P1 contained in the first photosensitive glass paste 12 can be reduced.

### [First Modification]

[Structure of Optical Coupler 1a]

Hereinafter, an optical coupler 1a according to a first modification of the present disclosure will be described. Note that, regarding the structure of the optical coupler 1a according to the first modification, portions different from the structure of the optical coupler 1 according to the first embodiment will only be described, and description of the other portions will be omitted.

In the present modification, the longest length r1 of each of the plurality of first fillers P1 is smaller than the wavelength λ of the ultraviolet ray UV. Note that, in the present modification, the longest length r1 of each of the plurality of first fillers P1 may be equal to or larger than the wavelength λ of the ultraviolet ray UV. In the present modification, the optical coupler 1a may not contain the first filler P1. Note that, in the present modification, the optical coupler 1a corresponds to the “first glass part” of the present disclosure.

[Method of Manufacturing Optical Coupler 1a]

Next, a method of manufacturing the optical coupler 1a according to the first modification of the present disclosure will be described with reference to the drawings. FIG. 11 is a perspective view of the light-transmitting substrate 11. Note that, in FIG. 11, a representative third filler P3 among a plurality of third fillers P3 is only denoted by a reference symbol. Note that, regarding the method of manufacturing the optical coupler 1a according to the first modification, portions different from the method of manufacturing the optical coupler 1 according to the first embodiment will only be described, and description of the other portions will be omitted.

The light-transmitting substrate 11 contains a medium M2 and a plurality of third fillers P3 mixed in the medium M2. The medium M2 is, for example, a resin. Note that the medium M2 may be glass or the like.

The plurality of third fillers P3 are metal oxide particles such as crystalline silica, amorphous silica, alumina, magnesium oxide, titanium oxide, barium titanate, or calcium titanate, or organic particles such as graphite. The third fillers P3 include a filler having a non-spherical shape. The plurality of third fillers P3 are dispersed throughout the medium M2. Note that the third fillers P3 may not contain a filler having a non-spherical shape. In addition, the plurality of third fillers P3 may be uniformly dispersed throughout the medium M2, or may be non-uniformly dispersed throughout the medium M2.

The longest length of each of the plurality of third fillers P3 is defined as r3. Note that, in a case where each of the plurality of third fillers P3 has a spherical shape, the longest length r3 of each of the plurality of third fillers P3 is the diameter of the sphere. In a case where each of the plurality of third fillers P3 has an elliptical spherical shape, the longest length r3 of each of the plurality of third fillers P3 is the length, in the major axis direction, of the elliptical sphere. As described above, the longest length r3 of each of the plurality of third fillers P3 is the length, in the longitudinal direction, of the longest portion of each of the plurality of third fillers P3. In the present modification, the maximum value of the longest length r3 of each of the plurality of third fillers P3 is larger than the wavelength λ of the ultraviolet ray UV. Therefore, the maximum value of the longest length r3 of each of the plurality of third fillers P3 is larger than the maximum value of the longest length r1 of each of the plurality of first fillers P1. There is the third filler P3 having the longest length r3 larger than the maximum value of the longest length r1 of the first filler P1.

In the present modification, the light-transmitting substrate 11 may not be removed from the first photosensitive glass paste 12 developed, in the curing step. That is, the light-transmitting substrate 11 may be connected to the optical coupler 1a. In this case, the light-transmitting substrate 11 corresponds to the “transparent part” of the present disclosure.

Also in the method of manufacturing the optical coupler 1a as described above, the same effects as those of the method of manufacturing the optical coupler 1 are obtained. In addition, according to the method of manufacturing the optical coupler 1a, the content of the first filler P3 contained in the first photosensitive glass paste 12 can be reduced. In more detail, the longest length r3 of the third filler P3 contained in the light-transmitting substrate 11 is larger than the wavelength λ of the ultraviolet ray UV. As a result, the ultraviolet ray UV diffracted by the periodic structure of the light-transmitting region a and the light-shielding region b of the grayscale mask 10 is scattered by the third filler P3 contained in the light-transmitting substrate 11. As a result, the light intensity distribution of the ultraviolet ray UV becomes a normal distribution that is the strongest at the position x1, in which the light intensities I (x) distributed at positions other than the position x1 become smaller than those of the comparative example, and the positions other than the position x1 are not irradiated with high levels of the ultraviolet ray UV. Therefore, the portions, other than the position x1, of the first photosensitive glass paste 12 are less likely to remain in the developing step. As a result, if the content of the first filler P3 contained in the first photosensitive glass paste 12 is reduced, a decrease in processing accuracy can be suppressed. As a result, according to the method of manufacturing the optical coupler 1a, the content of the first filler P3 contained in the first photosensitive glass paste 12 can be reduced.

In addition, according to the method of manufacturing the optical coupler 1a, the processing accuracy of the optical coupler 1a can be improved. In more detail, the third fillers P3 include a filler having a non-spherical shape. Compared to the case where the third fillers P3 include only fillers each having a spherical shape, this makes it possible to further generate scattering of the ultraviolet ray UV. Therefore, according to the method of manufacturing the optical coupler 1a, the content of the third filler P3 contained in the light-transmitting substrate 11 can be reduced. As a result, according to the method of manufacturing the optical coupler 1a, the processing accuracy of the optical coupler 1a can be improved.

### [Second Modification]

[Structure of Optical Coupler 1b]

Hereinafter, an optical coupler 1b according to a second modification of the present disclosure will be described with reference to the drawings. FIG. 12 is a sectional view of the optical coupler 1b and the optical fiber 5. Note that, in FIG. 12, the second side wall part 22 and the third side wall part 23 are omitted. Note that, regarding the structure of the optical coupler 1b according to the second modification, portions different from the structure of the optical coupler 1 according to the first embodiment will only be described, and description of the other portions will be omitted.

In the present modification, a plurality of first fillers P1 are contained only in the bottom part 24, and no filler is contained in each of the first side wall part 21, the second side wall part 22, the third side wall part 23, the reflective part 3, and the optical fiber fixing part 4. Note that the plurality of first fillers P1 may be contained only in the end surface S1, in the direction opposite to the first direction DIR1, of the bottom part 24 and no filler may be contained in portions other than the end surface S1, in the direction opposite to the first direction DIR1, of the bottom part 24. Note that, in the present modification, the bottom part 24 corresponds to the “first glass part” of the present disclosure. Each of the first side wall part 21, the second side wall part 22, the third side wall part 23, the reflective part 3, and the optical fiber fixing part 4 corresponds to the “second glass part” or the “transparent part” of the present disclosure. The “second glass part” of the present disclosure contains at least glass.

[Method of Manufacturing Optical Coupler 1b]

Next, a method of manufacturing the optical coupler 1b according to the second modification of the present disclosure will be described with reference to the drawings. FIG. 13 is a flowchart illustrating the method of manufacturing the optical coupler 1b. FIG. 14 is a sectional view during the manufacturing of the optical coupler 1b. Note that, in FIG. 14, the second side wall part 22 and the third side wall part 23 are omitted. Note that, regarding the method of manufacturing the optical coupler 1b according to the second modification, portions different from the method of manufacturing the optical coupler 1 according to the first embodiment will only be described, and description of the other portions will be omitted.

In the present modification, after the first application step, second photosensitive glass paste 13 containing no filler is applied to the first photosensitive glass paste 12 (second application step, FIG. 13: step ST21). In the present modification, the second photosensitive glass paste 13 is of a negative type. Note that, in a case where the first photosensitive glass paste 12 is of a positive type, the second photosensitive glass paste 13 may be of a positive type. Note that the second photosensitive glass paste 13 may contain additives, such as a dispersant and a light absorbent, in addition to glass. Note that the second application step may be performed after the mask step. It is fine if the second application step is performed between the first application step and the exposure step.

### When the Capacitor of the Present Disclosure is the Film

In the exposure step, the second main surface SU12 of the light-transmitting substrate 11 is irradiated with the ultraviolet ray UV to expose the first photosensitive glass paste 12 and the second photosensitive glass paste 13 (FIG. 13: step ST4). Through the exposure step, the first photosensitive glass paste 12 and the second photosensitive glass paste 13 are exposed to light.

In the developing step, the grayscale mask 10 is removed from the second main surface SU12 of the light-transmitting substrate 11, and the first photosensitive glass paste 12 and the second photosensitive glass paste 13 are developed (FIG. 13: step ST5). In more detail, the first photosensitive glass paste 12, the second photosensitive glass paste 13, and the light-transmitting substrate 11 are immersed in a developing solution. Through the developing step, exposed portions of the first photosensitive glass paste 12 and the second photosensitive glass paste 13 remain, and unexposed portions are removed. After the development, the first photosensitive glass paste 12, the second photosensitive glass paste 13, and the light-transmitting substrate 11 are washed and dried.

In the curing step, the light-transmitting substrate 11 is removed from the first photosensitive glass paste 12 developed, and the first photosensitive glass paste 12 and the second photosensitive glass paste 13 are cured (FIG. 13: step ST6). In more detail, the first photosensitive glass paste 12 and the second photosensitive glass paste 13 are fired to cure the first photosensitive glass paste 12 and the second photosensitive glass paste 13.

Also in the method of manufacturing the optical coupler 1b as described above, the same effects as those of the method of manufacturing the optical coupler 1 are obtained. In more detail, the second main surface SU12 of the light-transmitting substrate 11 is irradiated with the ultraviolet ray UV in the exposure step. Therefore, since the longest length r1 of the first filler P1 contained in the first photosensitive glass paste 12 applied to the first main surface SU11 of the light-transmitting substrate 11 is larger than the wavelength λ of the ultraviolet ray UV, the ultraviolet ray UV diffracted by the periodic structure of the light-transmitting region a and the light-shielding region b of the grayscale mask 10 is scattered by the first filler P1. As a result, the light intensity distribution of the ultraviolet ray UV becomes a normal distribution that is the strongest at the position x1, in which the light intensities I (x) distributed at positions other than the position x1 become smaller than those of the comparative example, and the positions other than the position x1 are not irradiated with high levels of the ultraviolet ray UV. Therefore, the portions, other than the position x1, of the first photosensitive glass paste 12 and the second photosensitive glass paste 13 are less likely to remain in the developing step. Therefore, if the second photosensitive glass paste 13 applied to the first photosensitive glass paste 12 contains no filler, the same effects as those of the method of manufacturing the optical coupler 1 are obtained.

According to the method of manufacturing the optical coupler 1b, the second photosensitive glass paste 13 contains no filler. Therefore, according to the method of manufacturing the optical coupler 1b, the shape accuracy of the optical coupler 1b can be improved.

### [Third Modification]

[Structure of Optical Coupler 1c]

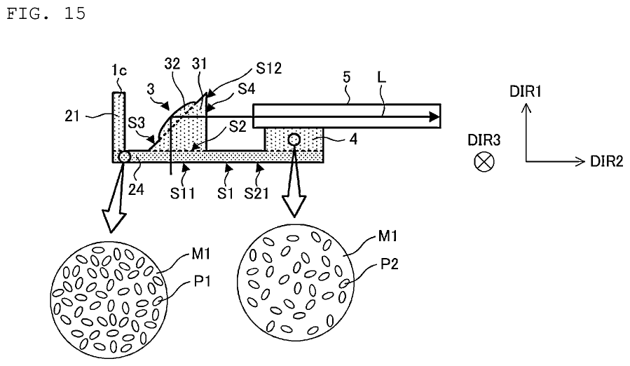

Hereinafter, an optical coupler 1c according to a third modification of the present disclosure will be described. FIG. 15 is a sectional view of the optical coupler 1c and the optical fiber 5. Note that, in FIG. 15, the second side wall part 22 and the third side wall part 23 are omitted. Note that, regarding the structure of the optical coupler 1c according to the third modification, portions different from the structure of the optical coupler 1b according to the second modification will only be described, and description of the other portions will be omitted.

In the present modification, the bottom part 24 contains the glass M1 and a plurality of first fillers P1 mixed in the glass M1. Each of the first side wall part 21, the second side wall part 22, the third side wall part 23, the reflective part 3, and the optical fiber fixing part 4 contains the glass M1 and a plurality of second fillers P2 mixed in the glass M1. The content of the second filler P2 contained in each of the first side wall part 21, the second side wall part 22, the third side wall part 23, the reflective part 3, and the optical fiber fixing part 4 is lower than the content of the first filler P1 contained in the bottom part 24. Note that the content of the second filler P2 contained in a portion other than the end surface S1, in the direction opposite to the first direction DIR1, of the bottom part 24 may be lower than the content of the first filler P1 contained in the end surface S1, in the direction opposite to the first direction DIR1, of the bottom part 24.

The plurality of second fillers P2 are metal oxide particles such as crystalline silica, amorphous silica, alumina, magnesium oxide, titanium oxide, barium titanate, or calcium titanate, or organic particles such as graphite. The second fillers P2 include a filler having a non-spherical shape. The plurality of second fillers P2 are dispersed throughout the glass M1. Note that the second fillers P2 may not include a filler having a non-spherical shape. In addition, the plurality of second fillers P2 may be uniformly dispersed throughout the glass M1, or may be non-uniformly dispersed throughout the glass M1.

[Method of Manufacturing Optical Coupler 1c]

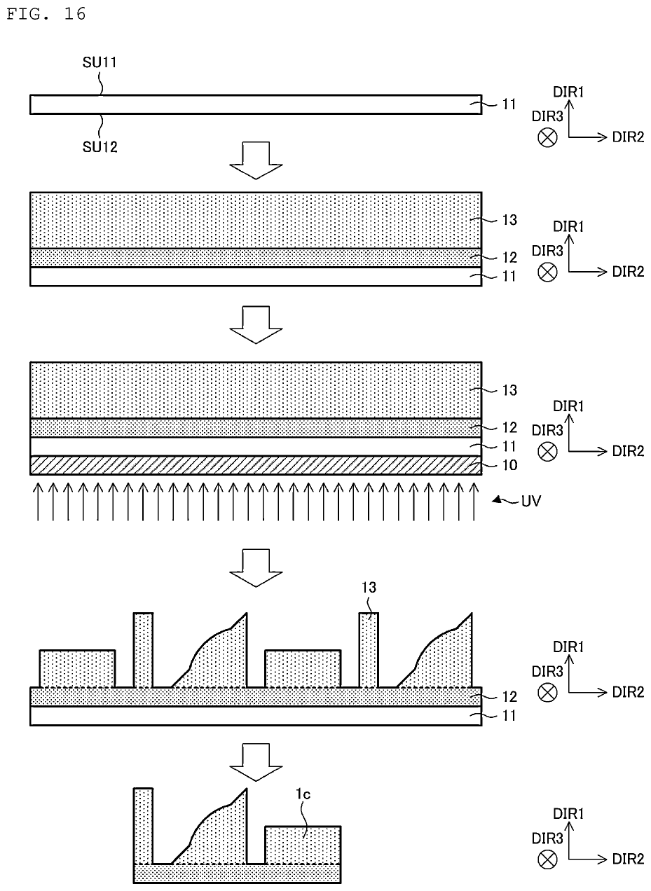

Next, a method of manufacturing the optical coupler 1c according to the third modification of the present disclosure will be described with reference to the drawings. FIG. 16 is a sectional view during the manufacturing of the optical coupler 1c. Note that, in FIG. 16, the second side wall part 22 and the third side wall part 23 are omitted. Note that, regarding the method of manufacturing the optical coupler 1c according to the third modification, portions different from the method of manufacturing the optical coupler 1b according to the second modification will only be described, and description of the other portions will be omitted.

In the present modification, after the first application step, second photosensitive glass paste 13 containing the second filler P2 is applied to the first photosensitive glass paste 12 (second application step). The content of the second filler P2 contained in the second photosensitive glass paste 13 is lower than the content of the first filler P1 contained in the first photosensitive glass paste 12. Note that the second application step may be performed after the mask step. It is fine if the second application step is performed between the first application step and the exposure step.

Also in the method of manufacturing the optical coupler 1c as described above, the same effects as those of the method of manufacturing the optical coupler 1b are obtained. In more detail, if the content of the second filler P2 contained in the second photosensitive glass paste 13 applied to the first photosensitive glass paste 12 is lower than the content of the first filler P1 contained in the first photosensitive glass paste 12, the same effects as those of the method of manufacturing the optical coupler 1b are obtained for the same reason as that of the method of manufacturing the optical coupler 1b.

According to the method of manufacturing optical coupler 1c, the content of the second filler P2 contained in the second photosensitive glass paste 13 is lower than the content of the first filler P1 contained in the first photosensitive glass paste 12. Therefore, according to the method of manufacturing the optical coupler 1c, the shape accuracy of the optical coupler 1c can be improved.

### [Fourth Modification]

[Structure of Optical Coupler 1d]

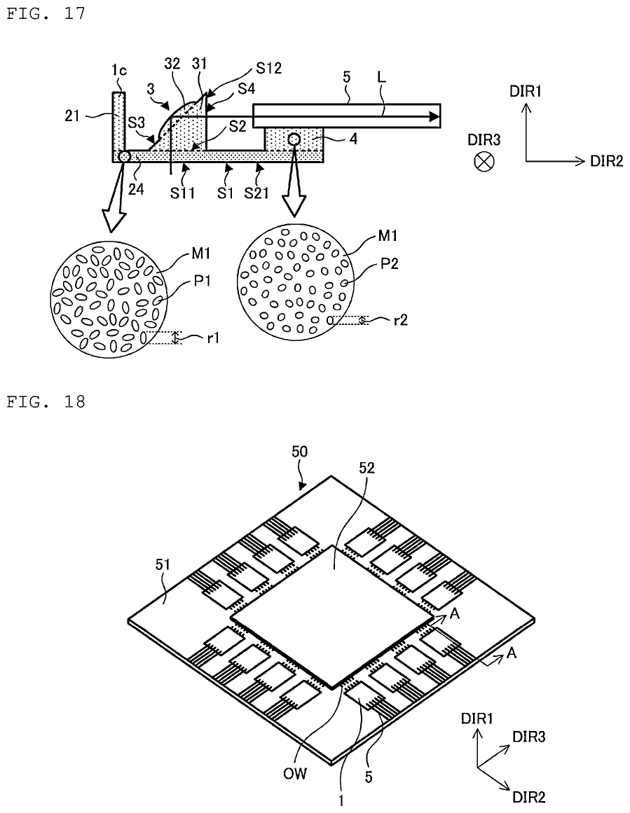

Hereinafter, an optical coupler 1d according to a fourth modification of the present disclosure will be described with reference to the drawings. FIG. 17 is a sectional view of the optical coupler 1d and the optical fiber 5. Note that, in FIG. 17, the second side wall part 22 and the third side wall part 23 are omitted. Note that, regarding the structure of the optical coupler 1d according to the fourth modification, portions different from the structure of the optical coupler 1c according to the third modification will only be described, and description of the other portions will be omitted.

The longest length of each of the plurality of second fillers P2 is defined as r2. Note that, in a case where each of the plurality of second fillers P2 has a spherical shape, the longest length r2 of each of the plurality of second fillers P2 is the diameter of the sphere. In a case where each of the plurality of second fillers P2 has an elliptical spherical shape, the longest length r2 of each of the plurality of second fillers P2 is the length, in the major axis direction, of the elliptical sphere. As described above, the longest length r2 of each of the plurality of second fillers P2 is the length, in the longitudinal direction, of the longest portion of each of the plurality of second fillers P2. In the present modification, the maximum value of the longest length r2 of each of the plurality of second fillers P2 is larger than zero and equal to or smaller than the wavelength λ of the ultraviolet ray UV. Therefore, the maximum value of the longest length r2 of each of the plurality of second fillers P2 is smaller than the maximum value of the longest length r1 of each of the plurality of first fillers P1. There is the first filler P1 having the longest length r1 larger than the maximum value of the longest length r2 of the second filler P2. The maximum value of the longest length r2 of each of the plurality of second fillers P2 is different from the maximum value of the longest length r1 of each of the plurality of first fillers P1.

[Method of Manufacturing Optical Coupler 1d]

Hereinafter, the optical coupler 1d according to the fourth modification of the present disclosure will be described. Note that, regarding the method of manufacturing the optical coupler 1d according to the fourth modification, portions different from the method of manufacturing the optical coupler 1c according to the third modification will only be described, and description of the other portions will be omitted.

In the present modification, the maximum value of the longest length r2 of each of the plurality of second fillers P2 contained in the second photosensitive glass paste 13 is larger than zero and equal to or smaller than the wavelength λ of the ultraviolet ray UV.

Also in the method of manufacturing the optical coupler 1d as described above, the same effects as those of the method of manufacturing the optical coupler 1c are obtained. In more detail, if the longest length r2 of the second filler P2 contained in the second photosensitive glass paste 13 applied to the first photosensitive glass paste 12 is larger than zero and equal to or smaller than the wavelength λ of the ultraviolet ray UV, the same effects as those of the method of manufacturing the optical coupler 1c are obtained for the same reason as that of the method of manufacturing the optical coupler 1c.

According to the method of manufacturing the optical coupler 1d, the longest length r2 of the second filler P2 contained in the second photosensitive glass paste 13 is larger than zero and equal to or smaller than the wavelength λ of the ultraviolet ray UV. Therefore, according to the method of manufacturing the optical coupler 1d, the shape accuracy of the optical coupler 1d can be improved.

### [Fifth Modification]

### [Structure of Photoelectric Conversion Circuit Module 50]

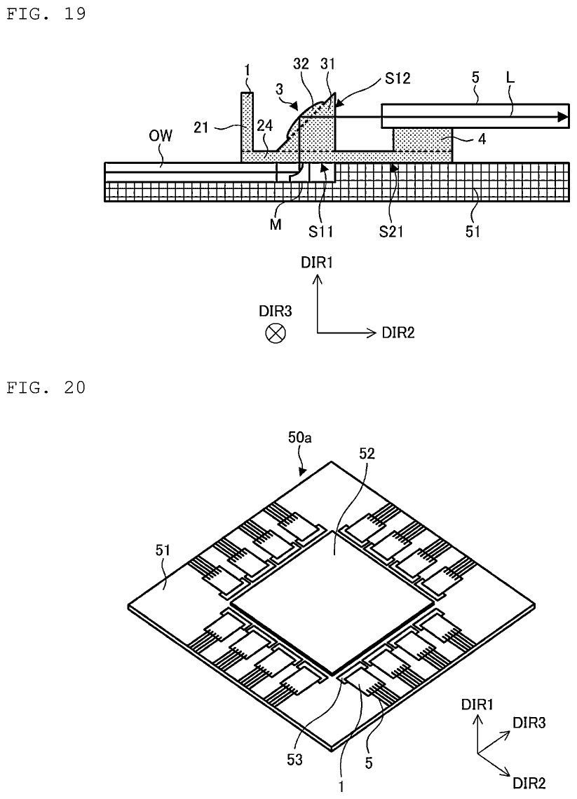

Hereinafter, a photoelectric conversion circuit module 50 according to a fifth modification will be described with reference to the drawings. FIG. 18 is a perspective view of the photoelectric conversion circuit module 50 and the optical fiber 5. Note that, in FIG. 18, the representative optical coupler 1, optical fiber 5, and optical waveguide OW among a plurality of optical couplers 1, a plurality of optical fibers 5, and a plurality of optical waveguides OW are only denoted by reference symbols. FIG. 19 is an A-A sectional view of the photoelectric conversion circuit module 50 and the optical fiber 5.

As illustrated in FIG. 18, the photoelectric conversion circuit module 50 includes a plurality of optical couplers 1, a substrate 51, and a photoelectric conversion circuit 52. The plurality of optical couplers 1 and the photoelectric conversion circuit 52 are mounted on the substrate 51. The photoelectric conversion circuit 52 is arranged at the center of the substrate 51 as viewed in the first direction DIR1. The plurality of optical couplers 1 are arranged around the photoelectric conversion circuit 52 as viewed in the first direction DIR1. Each of the plurality of optical fibers 5 is fixed to the optical fiber fixing part 4 of each of the plurality of optical couplers 1. Note that the number of the optical couplers 1 is not limited to multiple units; it may also be just one. In addition, the photoelectric conversion circuit 52 may not be arranged at the center of the substrate 51 as viewed in the first direction DIR1. In addition, the plurality of optical couplers 1 may not be arranged around the photoelectric conversion circuit 52 as viewed in the first direction DIR1. In addition, the photoelectric conversion circuit module 50 may include the optical coupler 1a, the optical coupler 1b, the optical coupler 1c, or the optical coupler 1d instead of the optical coupler 1.

The substrate 51 has a plate shape having two main surfaces aligned in the first direction DIR1. However, the optical waveguide OW and a mirror M are provided inside the substrate 51, as illustrated in FIG. 19. The optical waveguide OW is provided between the photoelectric conversion circuit 52 and each of the plurality of optical couplers 1. The mirror M is provided in the direction opposite to the first direction DIR1 from the reflective part 3. The light L emitted from the photoelectric conversion circuit 52 passes through the optical waveguide OW.

The plurality of optical couplers 1 are mounted on the main surface, located closer to the first direction DIR1, of the two main surfaces of the substrate 51. In more detail, the mounting surface S21 is mounted on the main surface, located closer to the first direction DIR1, of the two main surfaces of the substrate 51.

The photoelectric conversion circuit 52 is mounted on the main surface, located closer to the first direction DIR1, of the two main surfaces of the substrate 51. The photoelectric conversion circuit 52 converts an electrical signal into light to enter the optical coupler 1 or converts the light emitted from the optical coupler 1 into an electrical signal. A case where the photoelectric conversion circuit 52 converts an electrical signal into light to enter the optical coupler 1 will be described.

The photoelectric conversion circuit 52 converts an electrical signal into the light L to enter each of the plurality of optical couplers 1. The light L emitted by the photoelectric conversion circuit 52 travels in the optical waveguide OW in the second direction DIR2. The light L traveling in the optical waveguide OW in the second direction DIR2 is reflected by the mirror M. As a result, the traveling direction of the light L is changed from the second direction DIR2 to the first direction DIR1. Thereafter, the light L enters the incident surface S11 of the optical coupler 1, the traveling direction is changed from the first direction DIR1 to the second direction DIR2 by the optical coupler 1, and the light L is emitted from the emission surface S12 of the optical coupler 1. As a result, the light L enters each of the five optical fibers 5.

Also in the photoelectric conversion circuit module 50 as described above, the same effects as those of the optical coupler 1 are obtained.

### [Sixth Modification]

Structure of Photoelectric Conversion Circuit Module 50a]

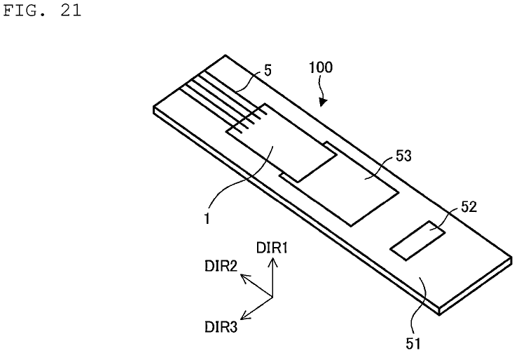

Hereinafter, a photoelectric conversion circuit module 50a according to a sixth modification will be described with reference to the drawings. FIG. 20 is a perspective view of the photoelectric conversion circuit module 50a and the optical fiber 5. Note that, in FIG. 20, the presentative optical coupler 1 and optical fiber 5 among a plurality of optical couplers 1 and a plurality of optical fibers 5 are only denoted by reference signals. Note that, regarding the photoelectric conversion circuit module 50a according to the sixth modification, portions different from the photoelectric conversion circuit module 50 according to the fifth modification will be described, and description of the other portions will be omitted.

The photoelectric conversion circuit module 50a is different from the photoelectric conversion circuit module 50 in that the substrate 51 is a semiconductor substrate and the substrate 51 includes a plurality of light-emitting parts 53. Note that the number of the light-emitting parts 53 is not limited to multiple units; it may also be just one.

Each of the plurality of light-emitting parts 53 is, for example, a surface-emitting element formed on the main surface, located closer to the first direction DIR1, of the two main surfaces of the substrate 51. Each of the plurality of light-emitting parts 53 is, for example, a vertical cavity surface emitting laser (VCSEL). Each of the plurality of light-emitting parts 53 emits the light L on the basis of an electrical signal generated by the photoelectric conversion circuit 52. The light L emitted by each of the plurality of light-emitting parts 53 enters each of the plurality of optical fibers 5 with each of the plurality of optical couplers 1 interposed therebetween.

Also in the photoelectric conversion circuit module 50a as described above, the same effects as those of the photoelectric conversion circuit module 50 are obtained.

### [Seventh Modification]

### [Structure of Optical Transceiver 100]

Hereinafter, an optical transceiver 100 will be described with reference to the drawings. FIG. 21 is a perspective view of the optical transceiver 100 and the optical fiber 5. Note that, in FIG. 21, the representative optical fiber 5 among the five optical fibers 5 is only denoted by a reference signal. Note that, regarding the optical transceiver 100 according to the seventh modification, portions different from the photoelectric conversion circuit module 50a according to the sixth modification will only be described, and description of the other portions will be omitted.

The optical transceiver 100 is different from the photoelectric conversion circuit module 50a in that the number of the optical couplers 1 is one and the number of the light-emitting parts 53 is one.

The light L emitted by the light-emitting part 53 enters each of the five optical fibers 5 with the optical coupler 1 interposed therebetween, or the light L emitted by each of the five optical fibers 5 enters the photoelectric conversion circuit 52 with the optical coupler 1 interposed therebetween.

Also in the optical transceiver 100 as described above, the same effects as those of the photoelectric conversion circuit module 50a are obtained.

### OTHER EMBODIMENTS

The optical coupler according to the present disclosure is not limited to the optical coupler 1, the optical coupler 1a, the optical coupler 1b, the optical coupler 1c, and the optical coupler 1d, and can be changed within the scope of the gist thereof. In addition, the structures of the optical coupler 1, the optical coupler 1a, the optical coupler 1b, the optical coupler 1c, and the optical coupler 1d may be arbitrarily combined.

The photoelectric conversion circuit module according to the present disclosure is not limited to the photoelectric conversion circuit module 50 and the photoelectric conversion circuit module 50a, and can be changed within the scope of the gist thereof. In addition, the structures of the photoelectric conversion circuit module 50 and the photoelectric conversion circuit module 50a may be arbitrarily combined.

The optical transceiver according to the present disclosure is not limited to the optical transceiver 100, and can be changed within the scope of the gist thereof.

The present disclosure has the following configurations.
(1) A method of manufacturing an optical coupler, the method including: preparing a light-transmitting substrate having a first main surface and a second main surface aligned in a first direction; applying a first photosensitive glass paste containing a first filler to the first main surface; arranging a grayscale mask formed in a binary pattern on the second main surface; emitting an ultraviolet ray to the second main surface to expose the first photosensitive glass paste; removing the grayscale mask from the second main surface and developing the first photosensitive glass paste; and removing the light-transmitting substrate from the first photosensitive glass paste developed and curing the first photosensitive glass paste, in which a longest length of the first filler is larger than a wavelength of the ultraviolet ray.
(2) The method of manufacturing an optical coupler according to (1), further including, between the application of the first filler and the emitting of the ultraviolet ray to the second main surface, applying a second photosensitive glass paste to the first photosensitive glass paste, in which: the first photosensitive glass paste and the second photosensitive glass paste are exposed; the first photosensitive glass paste and the second photosensitive glass paste are developed; the first photosensitive glass paste and the second photosensitive glass paste are cured; and (1) the second photosensitive glass paste contains a second filler, and a content of the second filler contained in the second photosensitive glass paste is lower than a content of the first filler contained in the first photosensitive glass paste, or (2) the second photosensitive glass paste does not contain the second filler.
(3) The method of manufacturing an optical coupler according to (1), further including, between the application of the first filler and the emitting of the ultraviolet ray to the second main surface, applying a second photosensitive glass paste containing a second filler to the first photosensitive glass paste, in which the first photosensitive glass paste and the second photosensitive glass paste are exposed, the first photosensitive glass paste and the second photosensitive glass paste are developed, the first photosensitive glass paste and the second photosensitive glass paste are cured, and a longest length of the second filler is larger than zero and equal to or smaller than a wavelength of the ultraviolet ray.
(4) The method of manufacturing an optical coupler according to any one of (1) to (3), in which the first filler includes a filler having a non-spherical shape.
(5) A method of manufacturing an optical coupler, the method including: preparing a light-transmitting substrate having a first main surface and a second main surface aligned in a first direction and containing a third filler; applying a first photosensitive glass paste to the first main surface; arranging a grayscale mask formed in a binary pattern on the second main surface; emitting an ultraviolet ray to the second main surface to expose the first photosensitive glass paste; removing the grayscale mask from the second main surface and developing the first photosensitive glass paste; and removing the light-transmitting substrate from the first photosensitive glass paste developed and curing the first photosensitive glass paste, in which a longest length of the third filler is larger than a wavelength of the ultraviolet ray.
(6) The method of manufacturing an optical coupler according to (5), in which the third filler includes a filler having a non-spherical shape.
(7) An optical coupler including a first photosensitive glass paste containing a first filler, in which a longest length of the first filler is larger than a wavelength of an ultraviolet ray to be emitted to a grayscale mask formed in a binary pattern.
(8) An optical coupler including: a first glass part containing first glass and a first filler mixed in the first glass; and a second glass part that contains at least second glass and is connected to the first glass part, in which (1) the second glass part contains a second filler mixed in the second glass, and a content of the second filler contained in the second glass part is lower than a content of the first filler contained in the first glass part, or (2) the second glass part does not contain the second filler.
(9) An optical coupler including: a first glass part; and a transparent part connected to the first glass part, in which the first glass part contains glass and a first filler mixed in the glass, the transparent part contains a medium and a second filler mixed in the medium, and a longest length of the second filler is different from a longest length of the first filler.
(10) The optical coupler according to (9), in which the medium is glass.
(11) The optical coupler according to any one of (7) to (10), in which the first filler includes a filler having a non-spherical shape.
(12) The optical coupler according to (9) or (10), in which the transparent part is a light-transmitting substrate.
(13) The optical coupler according to (12), in which the second filler includes a filler having a non-spherical shape.
(14) A photoelectric conversion circuit module including: the optical coupler according to any one of (7) to (13); a substrate; and a photoelectric conversion circuit on the substrate, in which the photoelectric conversion circuit converts an electrical signal into light to enter the optical coupler, or converts light emitted from the optical coupler into an electrical signal.
(15) The photoelectric conversion circuit module according to (14), in which the substrate is a semiconductor substrate and includes a light-emitting part that emits light, and the optical coupler is mounted on the substrate.
(16) An optical transceiver including the optical coupler according to any one of (7) to (13).

### DESCRIPTION OF REFERENCE SYMBOLS

1, 1a, 1b, 1c, 1d: Optical coupler
2: Holding part
3: Reflective part
4: Optical fiber fixing part
5: Optical fiber
10: Grayscale mask
11: Light-transmitting substrate
12: First photosensitive glass paste
13: Second photosensitive glass paste
15: Pixel
16: Unit region
17: Runner part
21: First side wall part
22: Second side wall part
23: Third side wall part
24: Bottom part
31: Prism part
32: Condenser lens part
50, 50a: Photoelectric conversion circuit module
51: Substrate
52: Photoelectric conversion circuit
53: Light-emitting part
100: Optical transceiver
A1, A2: Region
A11, A12, A21, A22: Square part
DIR1: First direction
DIR2: Second direction
DIR3: Third direction
G: Groove
I: Light intensity
L: Light
M: Mirror
M1: Glass
M2: Medium
OW: Optical waveguide
P1: First filler
P2: Second filler
P3: Third filler
S1: End surface
Sll: Incident surface
S12: Emission surface
S2: Prism part incident surface
S21: Mounting surface
S3: Prism part reflective surface
S4: Prism part emission surface
SU11: First main surface
SU12: Second main surface
UV: Ultraviolet ray
a: Light-transmitting region
b: Light-shielding region

1. A method of manufacturing an optical coupler, the method comprising:
preparing a light-transmitting substrate having a first main surface and a second main surface aligned in a first direction;
applying a first photosensitive glass paste containing a first filler to the first main surface;
arranging a grayscale mask formed in a binary pattern on the second main surface;
emitting an ultraviolet ray to the second main surface to expose the first photosensitive glass paste;
removing the grayscale mask from the second main surface and developing the first photosensitive glass paste; and
removing the light-transmitting substrate from the first photosensitive glass paste developed and curing the first photosensitive glass paste, wherein
a longest length of the first filler is larger than a wavelength of the ultraviolet ray.

2. The method of manufacturing an optical coupler according to claim 1, further comprising:
between the application of the first filler and the emitting of the ultraviolet ray to the second main surface, applying a second photosensitive glass paste to the first photosensitive glass paste, wherein
the first photosensitive glass paste and the second photosensitive glass paste are exposed,
the first photosensitive glass paste and the second photosensitive glass paste are developed,
the first photosensitive glass paste and the second photosensitive glass paste are cured, and
(1) the second photosensitive glass paste contains a second filler, and a content of the second filler contained in the second photosensitive glass paste is lower than a content of the first filler contained in the first photosensitive glass paste, or
(2) the second photosensitive glass paste does not contain the second filler.

3. The method of manufacturing an optical coupler according to claim 1, further comprising:
between the application of the first filler and the emitting of the ultraviolet ray to the second main surface, applying a second photosensitive glass paste containing a second filler to the first photosensitive glass paste, wherein
the first photosensitive glass paste and the second photosensitive glass paste are exposed,
the first photosensitive glass paste and the second photosensitive glass paste are developed,
the first photosensitive glass paste and the second photosensitive glass paste are cured, and
a longest length of the second filler is larger than zero and equal to or smaller than a wavelength of the ultraviolet ray.

4. The method of manufacturing an optical coupler according to claim 1, wherein the first filler includes a filler having a non-spherical shape.

5. A method of manufacturing an optical coupler, the method comprising:
preparing a light-transmitting substrate having a first main surface and a second main surface aligned in a first direction and containing a third filler;
applying a first photosensitive glass paste to the first main surface;
arranging a grayscale mask formed in a binary pattern on the second main surface;
emitting an ultraviolet ray to the second main surface to expose the first photosensitive glass paste;
removing the grayscale mask from the second main surface and developing the first photosensitive glass paste; and
removing the light-transmitting substrate from the first photosensitive glass paste developed and curing the first photosensitive glass paste, wherein
a longest length of the third filler is larger than a wavelength of the ultraviolet ray.

6. The method of manufacturing an optical coupler according to claim 5, wherein the third filler includes a filler having a non-spherical shape.

7. An optical coupler comprising:
a first photosensitive glass paste containing a first filler, wherein
a longest length of the first filler is larger than a wavelength of an ultraviolet ray to be emitted to a grayscale mask formed in a binary pattern.

8. The optical coupler according to claim 7, wherein the first filler includes a filler having a non-spherical shape.

9. An optical coupler comprising:
a first glass part containing first glass and a first filler mixed in the first glass; and
a second glass part that contains at least a second glass and is connected to the first glass part, wherein
(1) the second glass part contains a second filler mixed in the second glass, and a content of the second filler contained in the second glass part is lower than a content of the first filler contained in the first glass part, or
(2) the second glass part does not contain the second filler.

10. The optical coupler according to claim 9, wherein the first filler includes a filler having a non-spherical shape.

11. An optical coupler comprising:
a first glass part; and
a transparent part connected to the first glass part, wherein
the first glass part contains glass and a first filler mixed in the glass,
the transparent part contains a medium and a second filler mixed in the medium, and
a longest length of the second filler is different from a longest length of the first filler.

12. The optical coupler according to claim 11, wherein the medium is glass.

13. The optical coupler according to claim 11, wherein the first filler includes a filler having a non-spherical shape.

14. The optical coupler according to claim 11, wherein the transparent part is a light-transmitting substrate.

15. The optical coupler according to claim 14, wherein the second filler includes a filler having a non-spherical shape.

16. A photoelectric conversion circuit module comprising:
the optical coupler according to claim 7;
a substrate; and
a photoelectric conversion circuit on the substrate, wherein
the photoelectric conversion circuit converts an electrical signal into light to enter the optical coupler, or converts light emitted from the optical coupler into an electrical signal.

17. The photoelectric conversion circuit module according to claim 16, wherein
the substrate is a semiconductor substrate and includes a light-emitting part that emits light, and
the optical coupler is mounted on the substrate.

18. An optical transceiver comprising the optical coupler according to claim 7.
